(19) United States
(12) Patent Application Publication
(10) Pub. No.: US 2008/0090689 A1
(43) Pub. Date: Apr. 17, 2008

(54) Clutch assembly

(76) Inventor: Tzu-Pin Wang, Taiping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/545,567

(22) Filed: Oct. 11, 2006

(51) Int. Cl. F16H 47/08

(52) U.S. Cl. 475/93

(57) ABSTRACT

A clutch consists of transmission gears, pistons, a switch on each piston, and a passive gear; the transmission gears are fitted on a fly wheel; each piston is pivoted to an inner side of a clutch cover at a fixed end, and pivoted to a respective transmission gear at a moving end; the switches are provided for changing valves of the pistons between closed and open states, and have resilience so that they will return to closed position automatically when external force moving them to open position disappears; the passive gear is joined to a clutch shaft and engaged with the transmission gears; when the piston valves are in closed state, the piston moving ends will be immobilized to fix the transmission gears; therefore, the transmission gears will cause rotation of the passive gear and the clutch shaft when the fly wheel is rotating.

### BACKGROUND OF THE INVENTION

1. Field of the invention

The present invention relates to a clutch assembly, more particularly one, which includes two transmission gears fitted on a fly wheel, a clutch shaft joined to a speed change box, a passive gear securely joined to the clutch shaft and engaged with the transmission gears, and pistons connected to the transmission gears, which pistons can be moved to a closed state to fix the transmission gears to the fly wheel for the transmission gears to cause rotation of the passive gear and the clutch shaft when the transmission gears are rotated with the fly wheel.

2. Brief Description of the Prior Art

A conventional clutch consists of a clutch shaft, a passive clutch plate, an acting pressure plate, a clutch spring, a releasing lever, a releasing bearing, and a clutch cover; the clutch cover is joined to a fly wheel, which is driven by an engine, by means of threaded elements; the passive clutch plate, the acting pressure plate, the clutch spring, and the releasing lever are held in the clutch cover; the releasing lever is pivoted to the pressure plate; the pressure plate is pressed against the clutch plate by means of the clutch spring; the releasing bearing is fitted on the clutch shaft, and pressed against the releasing lever for making the fly wheel rotate together with the clutch assembly. When the clutch pedal is depressed, it will cause linear displacement of the releasing bearing on the clutch shaft so that the releasing lever causes displacement of the pressure plate, thus compressing the clutch spring to increase the space between the clutch plate and the fly wheel. Consequently, motion of the fly wheel is no longer passed on.

The above clutch assembly has a relatively complicated structure, and it takes relatively much force to operate the clutch assembly. Furthermore, the clutch spring is prone to suffer from elastic fatigue, which will result in malfunction of the clutch assembly. To overcome this problem, plate springs are developed to replace the above clutch spring and releasing lever. However, no matter which one is used, elasticity has to be used for making the pressure plate and the clutch plate touch/separate. Therefore, relatively large-sized clutches and powerful springs have to be used if the vehicles have greater horsepower; such large-sized clutches and powerful springs will make it more difficult to operate the clutch, and brake system of the vehicles can't function properly.

### SUMMARY OF THE INVENTION

It is a main object of the invention to provide an improvement on a clutch to overcome the above-mentioned problems.

The clutch of the present invention consists of transmission gears, pistons, a switch on each of the pistons, and a passive gear. The transmission gears are fitted on a fly wheel in a rotary manner. Each piston is pivoted to an inner side of a clutch cover at a fixed end, and pivoted to a respective one of the transmission gears at a moving end thereof. The switches are provided for changing valves of the pistons between closed and open states, and have resilience so that they will return to a closed position automatically when external force that moves them to an open position disappears. The passive gear is securely joined to a clutch shaft and engaged with the transmission gears. When the piston valves are in a closed state, the moving ends of the pistons will be immobilized to fix the transmission gears; therefore, the transmission gears will cause rotational motion of the passive gear and the clutch shaft when the fly wheel is rotating. When the valves of the pistons are in the open state, and the fly wheel is rotating, the transmission gears will revolve on their central points when moving around the passive gear, thus not causing rotational motion of the passive gear.

### BRIEF DESCRIPTION OF THE DRAWINGS

The present invention will be better understood by referring to the accompanying drawings, wherein:

FIG. 1 is an exploded perspective view of the present invention,

FIG. 2 is a perspective view of the piston of the present invention,

FIG. 3 is a lateral sectional view of the present invention,

FIG. 4 is a front sectional view of the present invention,

FIG. 5 is a lateral sectional view of the present invention, taken when the clutch pedal is depressed,

FIG. 6 is a front sectional view of the present invention, taken when the clutch pedal is depressed,

FIG. 7 is a lateral sectional view of the second preferred embodiment, and

FIG. 8 is a lateral sectional view of the second preferred embodiment, taken when the clutch is in the engaged position.

### DETAILED DESCRIPTION OF THE PREFERRED EMBODIMENTS

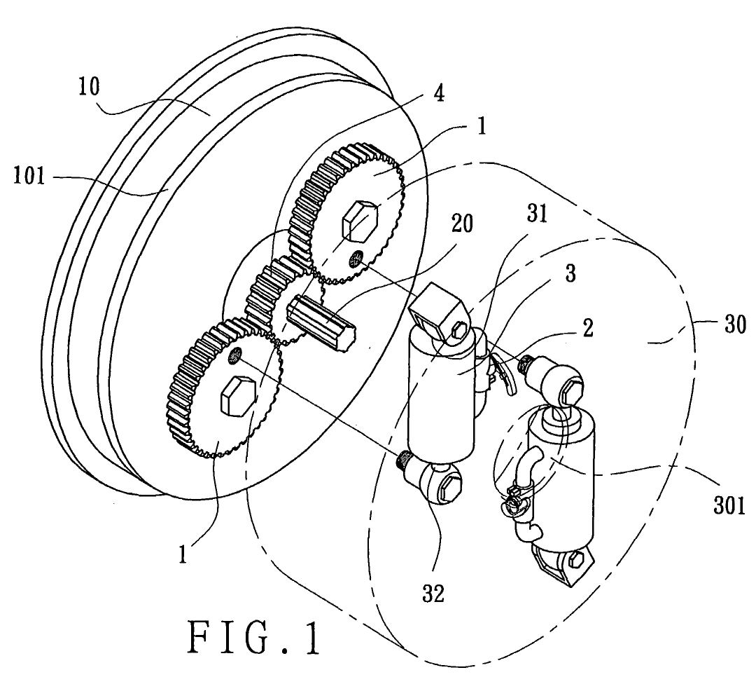

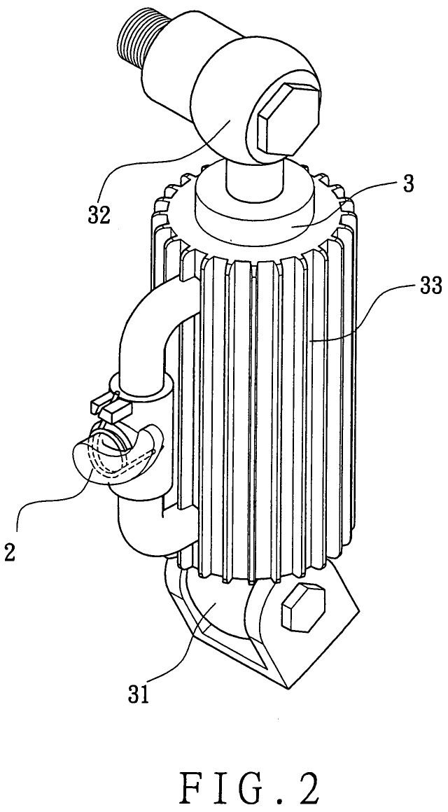

Referring to FIGS. 1 and 2, a preferred embodiment of a clutch assembly of the present invention consists of:

a clutch shaft 20, the clutch shaft 20 is connected to a speed change box;

a pilot operated bearing 201;

a clutch cover 30 having a middle hole 301;

two transmission gears 1, the transmission gears 1 are fitted on a round disk 101 on a rear side of a fly wheel 10 of an engine in a rotary manner;

two pistons 3, the pistons 3 are connected to respective ones of the transmission gears 1;

two cock switches 2, the cock switches 2 are fitted on respective ones of the pistons 3 for changing valves of the pistons 3 between a closed state and an open one; the cock switches 2 have resilience so that they will return to a closed position automatically when an external force that moves the cock switches 2 to an open position disappears;

each of the pistons 3 has a valve on one side, and is connected to a respective one of the cock switches 2; each of the pistons 3 has a fixed end 31, and a moving end 32, and is pivoted to an inner side of the clutch cover 30 at the fixed end 31, and pivoted to a respective one of the transmission gears 1 at the moving end 32; gas such as air and nitrogen gas is contained in the pistons 3 for use instead of compression springs, and hydraulic oil such as automatic transmission fluid (ATF) is contained in the pistons 3 for preventing the gas from being overcompressed to cause malfunction of the clutch as well as for absorbing heat produced by friction; each of the pistons 3 is held in an aluminum heat dissipating device 33, which is provided for dissipating heat produced owing to motion of the pistons 3, as shown in FIG. 2; and

a passive gear 4, the passive gear 4 is securely joined to the clutch shaft 20, and engaged with the transmission gears so that rotational motion will be passed on to the speed change box connected to the clutch shaft 20 when the transmission gears 1 are rotated.

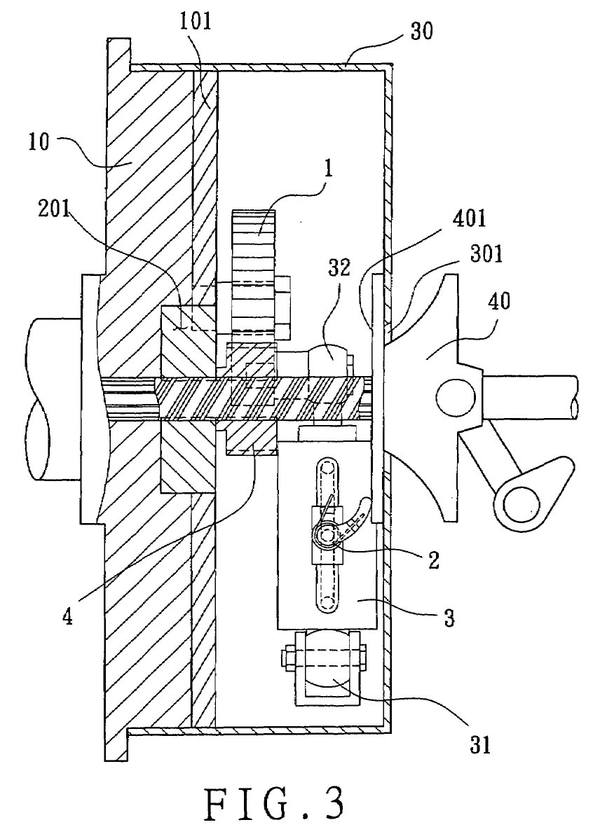

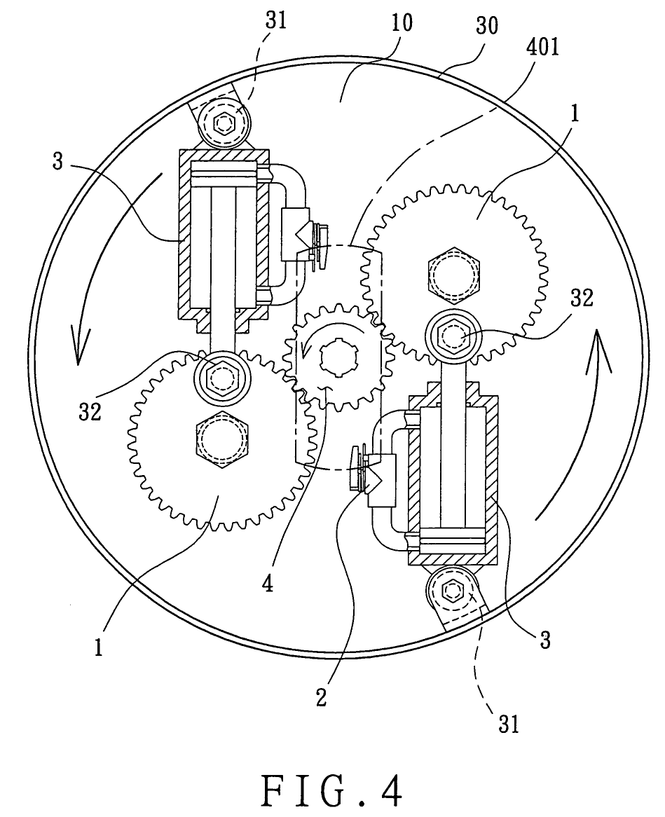

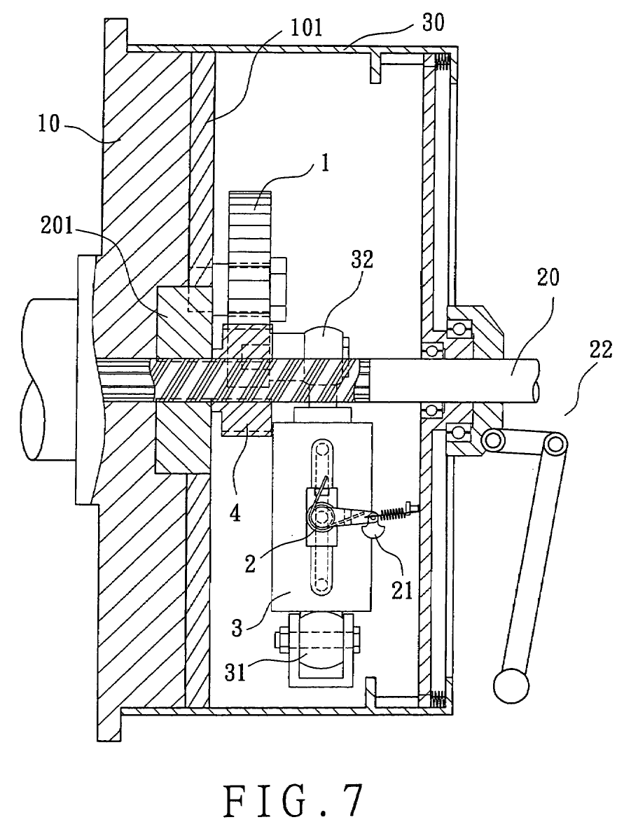

Referring to FIGS. 3 and 4, in assembly, the pistons 3 are pivoted to the inner side of the clutch cover 30 at the fixed ends 31 thereof with the cock switches 2 on the pistons 3 facing the middle hole 301 of the clutch cover 30, and the pistons 3 are pivoted to respective ones of the transmission gears 1, and the transmission gears 1 are fitted on the round disk 101 of the fly wheel 10 of the engine in a rotary manner. Referring to FIG. 7, the clutch shaft 20 is passed through the middle hole 301 of the clutch cover 30 at one end, and the passive gear 4 is securely joined to the clutch shaft 20 and engaged with the transmission gears 1. And, the clutch shaft 20 is passed through the fly wheel 10 in a rotary manner, and passed through and joined to the pilot operated bearing 201, and joined to the speed change box at the other end. Finally, the clutch cover 30 and the fly wheel 10 are joined together.

Referring to FIGS. 3 and 4, to use the above-mentioned clutch assembly on a manual shift car, a clutch pedal 40, and a pressure plate 401 have to be provided, which pressure plate 401 is joined to the clutch shaft 20. And, when the pressure plate 401 is in the non-acting position, the cock switches 2 will be on one side of the pressure plate 401 for the valves of the pistons 3 to be in the closed state; thus, the gas and hydraulic oil in the pistons 3 can't move freely, and the moving ends 32 of the pistons 3 are immobilized so as to fix the transmission gears 1 to the round disk 101 of the fly wheel 10, thus preventing the transmission gears 1 from turning on the fly wheel 10.

When the valves of the pistons 3 are in the closed state for the pistons 3 to fix the transmission gears 1, and the fly wheel 10 and the clutch cover 30 are driven to rotate together at high speed by means of an engine, the pistons 3 and the transmission gears 1 will be rotated together with the fly wheel 10 and the clutch cover 30, and in turn the transmission gears 1 will cause rotational motion of the passive gear 4 and the clutch shaft 20 joined to the passive gear 4. Consequently, the clutch is in its engaged position, and motion of the engine is passed on to the speed change box through the passive gear 4 and the clutch shaft 20.

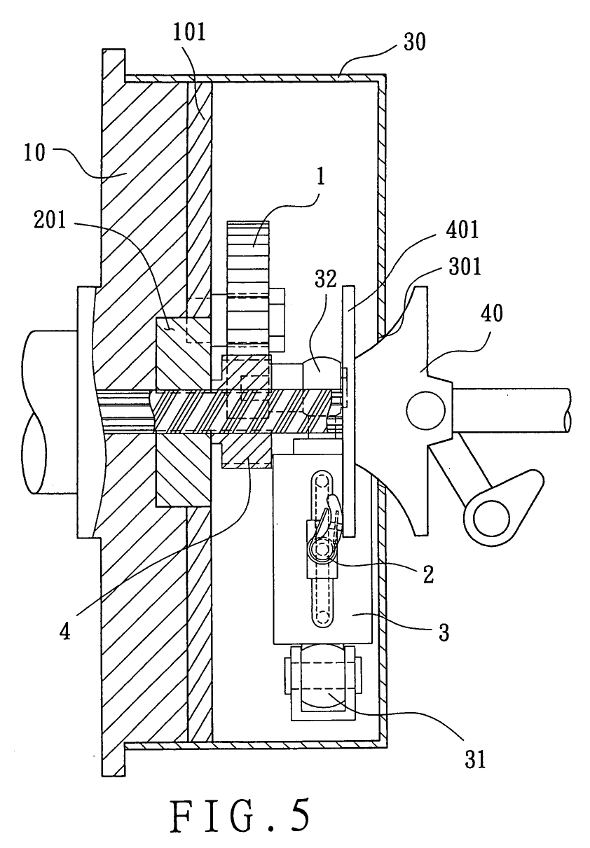

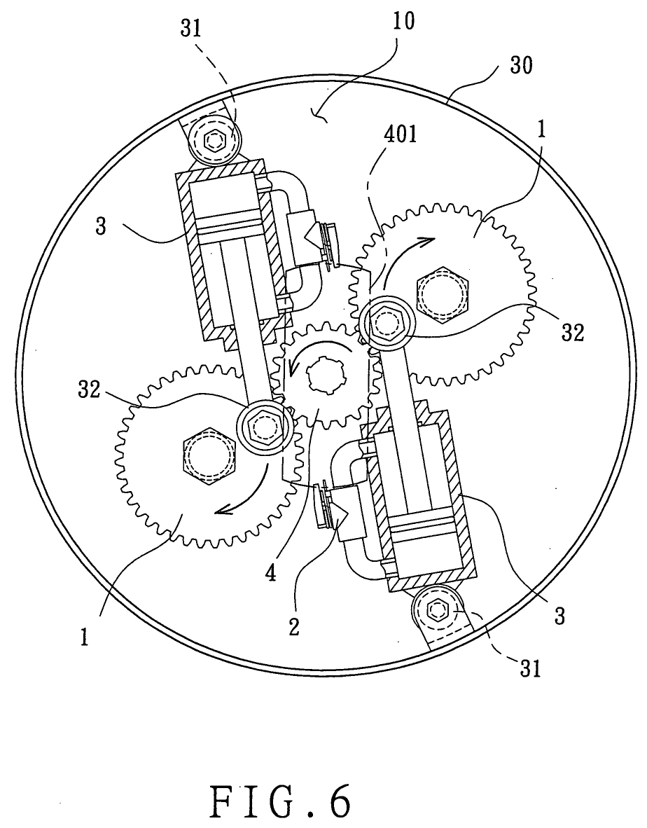

Referring to FIGS. 5 and 6, when the clutch pedal 40 is pressed, the clutch pedal 40 will push the pressure plate 401 for the pressure plate 401 to move the cock switches 2 to the open position; thus, the valves of the pistons 3 are in the open state, and the gas and hydraulic oil in the pistons 3 can move freely, and the moving ends 32 of the pistons 3 no longer fix the transmission gears 1 on the round disk 101 of the fly wheel 10. Therefore, when the transmission gears 1 are moved together with the round disk 101 owing to rotational motion of the fly wheel 10 and the clutch cover 30, the moving ends 32 of the pistons 3 will move in and out repeatedly, and the transmission gears 1 will revolve on their central points (shafts) when moving around the passive gear 4, not causing rotational motion of the passive gear 4. Consequently, referring to FIG. 7, the clutch is in its disengaged position, and the clutch shaft 20 joined to the passive gear 4 is still, and motion of the engine isn't passed on to the speed change box.

Referring to FIGS. 5 and 7, to use the above-mentioned clutch assembly on an automatic shift car, the cock switches 2 are equipped with heavy blocks 21, and a co-moving mechanism 22 is connected to the cocks 2 and a control circuit such that the clutch will be moved between the engaged position and the disengaged one by means of changing the magnitude of centrifugal force resulting from rotational motion of the fly wheel 10.

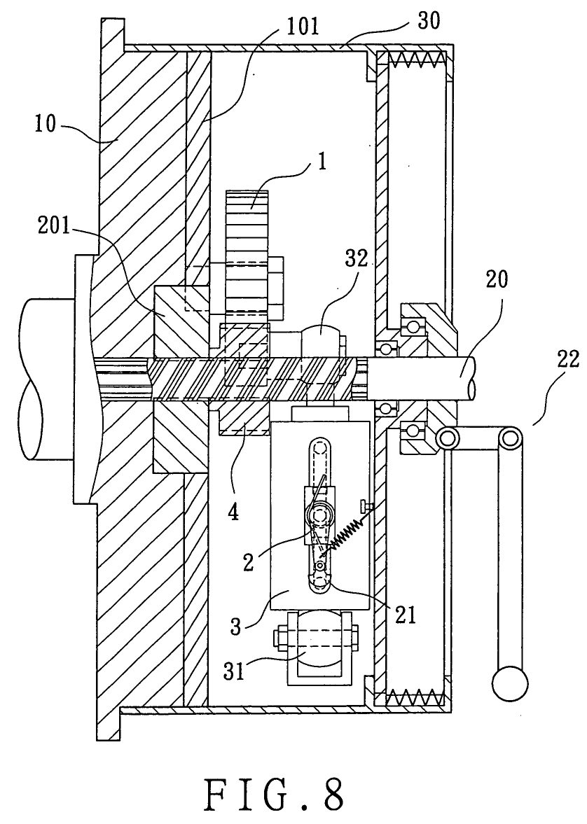

When the accelerator pedal of the car is depressed, centrifugal force of the heavy blocks 21 of the cock switches 2 will increase, and the heavy blocks 21 will move the cocks 2 to the closed position as shown in FIG. 8; thus, the valves of the pistons 3 are in the closed state for the pistons 3 to fix the transmission gears 1 on the round disk 101 of the fly wheel 10, and the pistons 3 and the transmission gears 1 will be rotated together with the fly wheel 10 and the clutch cover 30, and in turn the transmission gears 1 will cause rotational motion of the passive gear 4 and the clutch shaft 20 joined to the passive gear 4. Consequently, the clutch is in its engaged position, and motion of the engine is passed on to the speed change box through the passive gear 4 and the clutch shaft 20.

When the driver stops pressing the accelerator pedal for gearshift, centrifugal force of the heavy blocks 21 of the cocks 2 will decrease, and the cock switches 2 will be moved to the open position by means of the control circuit and the co-moving mechanism 22; thus, the valves of the pistons 3 are in the open state, and the gas and hydraulic oil in the pistons 3 can move freely, and the moving ends 32 of the pistons 3 no longer fix the transmission gears 1 on the round disk 101. Consequently, when the fly wheel 10 and the clutch cover 30 are rotating together, the transmission gears 1 will revolve on their central points (shafts) as well as moving around the passive gear 4, not causing rotational motion of the passive gear 4. Consequently, referring to FIG. 7, the clutch is in its disengaged position, and the clutch shaft 20 joined to the passive gear 4 is still, and motion of the engine won't be passed on to the speed change box.

Common automatic shift cars have built-in safety devices. Referring to FIG. 7, the cock switches 2 will be made to return to their open position by means of such a built-in safety device immediately after the speed change box is shifted to gear N or P; thus, the clutch will be always in the disengaged position regardless of the rotational speed.

From the above description, it can be seen that the clutch of the present invention can be fitted to an automatic shift car as well as a manual shift one. Furthermore, the pistons 3 of the present invention can be held in aluminum heat dissipating devices 33 (FIG. 2) so that high temperature produced by the pistons 3 can be rapidly dissipated, and the pistons 3 always in the best state.

What is claimed is:

1. A clutch assembly, comprising
a plurality of transmission gears, the transmission gears being fitted on a rear side of a fly wheel of an engine in a rotary manner;
a plurality of pistons, each of the pistons having a fixed end, and a moving end; the pistons being pivoted to an inner side of a clutch cover at the fixed ends, and pivoted to respective ones of the transmission gears at the moving ends thereof;
one switch on one side of each of the pistons for changing a valve of the piston between a closed state and an open one; the switches having resilience so that they will return to a closed position automatically when an external force that moves the switches to an open position disappears; and
a passive gear, the passive gear being securely joined to a clutch shaft and engaged with the transmission gears;
when the valves of the pistons are in said closed state, the moving ends of the pistons being immobilized so as to fix the transmission gears;
when the valves of the pistons are in said open state, the moving ends of the pistons being free to move, not going to fix the transmission gears;
whereby the transmission gears will cause rotational motion of the passive gear and the clutch shaft when the valves of the pistons are in said closed state, and the fly wheel is rotating; and
whereby when the valves of the pistons are in said open state, and the fly wheel is rotating, the transmission gears will revolve when moving around the passive gear, thus not causing rotational motion of the passive gear.

2. The clutch assembly as recited in claim 1 further having heat dissipating devices housing the pistons.

3. The clutch assembly as recited in claim 1, wherein the pistons contain gas, and hydraulic oil, which is used for preventing said gas from being overcompressed to cause malfunction of the clutch as well as for absorbing heat produced by friction.

4. The clutch assembly as recited in claim 3, wherein said gas contained in said pistons is air.

5. The clutch assembly as recited in claim 3, wherein said gas contained in said pistons is nitrogen.

6. The clutch assembly as recited in claim 3, wherein said hydraulic oil is automatic transmission fluid (ATF).

7. The clutch assembly as recited in claim 2, wherein the pistons contain gas, and hydraulic oil, which is used for preventing said gas from being overcompressed to cause malfunction of the clutch as well as for absorbing heat produced by friction.

8. The clutch assembly as recited in claim 7, wherein said gas contained in said pistons is air.

9. The clutch assembly as recited in claim 7, wherein said gas contained in said pistons is nitrogen.

10. The clutch assembly as recited in claim 7, wherein said hydraulic oil is automatic transmission fluid (ATF).

11. The clutch assembly as recited in claim 1, wherein said switches are cock switches, which are moved to an open position by means of external force, and back to a closed one by means of elasticity thereof.
